(19) United States
(12) Patent Application Publication
(10) Pub. No.: US 2006/0275532 A1
(43) Pub. Date: Dec. 7, 2006

(54) Ink jet printing of snacks with high reliability and image quality

(76) Inventor: Gary James Dechert, Fairfield, OH (US)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(21) Appl. No.: 11/410,676

(22) Filed: Apr. 25, 2006

Related U.S. Application Data
(60) Provisional application No. 60/679,948, filed on May 11, 2005.

(51) Int. Cl. A23P 1/00

(52) U.S. Cl. 426/383; 426/87

(57) ABSTRACT

A process for making edible substrates including the steps of: forming a substrate having an upper surface; providing at least one ink jet printer; printing an image onto the substrate with the inkjet printer to form a printed substrate; and cooking the printed substrate.

### CROSS REFERENCE TO RELATED APPLICATION

This application claims the benefit of U.S. Provisional Application Ser. No. 60/679,948, filed May 11, 2005 (P&G Case 9992P).

### FIELD OF INVENTION

The present invention relates to edible substrates having an image disposed thereon, particularly to methods to improve the reliability of disposing images on the edible substrates.

### BACKGROUND OF THE INVENTION

Foods provide more than just physical sustenance. The taste and appearance of food also provides enjoyment. Many popular food items, such as cookies, cakes, and candies, comprise some sort of decoration that makes the food item more visually appealing. Printing on edible items such as snacks can provide an added level of excitement beyond the snacking itself. The printed content can be in the form of graphics, text or combinations, and it can be used to deliver, for example, games, stories, jokes, and educational facts. Digital printing systems offer ways to print many varied images in succession over consecutive edible substrates like chips or cookies to maintain the interest of the consumer. Digital printing systems are, however, sensitive equipment susceptible to damage or malfunction in the environment where edibles are typically manufactured. The reliability of such equipment will often dictate the reliability of the overall production process and may determine the commercial and economical viability of printing edibles in mass quantities.

Printing on edibles that are further processed, for example, fried, introduces additional challenges. Excess ink, for example can leave the edible substrate surface and leach into the frying oil, or it can coat processing equipment. Ink that leaches into the oil can change its color, which may over time tint the overall product. This will create negative aesthetic issues, or impact the frying oil aging stability. Japanese patent publication 10-166545 describes printing apparatus and method to print on foodstuff prior to frying which employs a rotary screen printing machine and followed by an oil coated roller that removes excess ink from the printed foodstuff to hasten the drying of a printed aqueous ink and prevent the excess ink from leaching to the frying oil of a subsequent process step. But this removal process adds an additional processing step and additional equipment. Both of which increase the cost of the production process and the potential for breakdowns. Moreover, an oil coated roller may be prone to polymerization over extended run times making it undesirable for extended production runs.

Rotary screen printing also has other serious disadvantages, like limited variety. The number of images that can be printed is limited to those that can fit on the limited surface area of the printer roll. This limits the variety of printed images that can be supplied to consumers. Furthermore, if a greater number of images are desired, the roll must be changed. This results in expensive production stoppages, in addition to the added expense of a new roll. Another disadvantage is that the printer roll is required to contact the edible substrate, and that can have negative sanitation implications that are difficult to mitigate.

Accordingly, there exists a need for methods of printing edible substrates that have clear crisp images, with no additional processing steps. That is, it is desired to eliminate secondary processing steps such as excess ink removal. By doing this, the amount of time between equipment and product failures, as well as production shut-downs, can be extended. Minimizing equipment down time improves the economic viability of any industrial process. Also, it is advantageous to have such a method improve sanitation and be flexible in the amount of different images that can be printed without stopping the production process. The products and processes of the present invention provide these and other advantages over existing products and processes.

### SUMMARY OF THE INVENTION

In one aspect of the present invention there is provided a process for making printed edible substrates. This process includes the following steps: forming a substrate having an upper surface; providing at least one ink jet printer; printing an image onto the substrate with the inkjet printer to form a printed substrate; cooking the printed substrate. Preferably the inkjet printer is a drop-on-demand (DOD) piezoelectric ink jet printer that has at least one nozzle. In a preferred embodiment, an ink-jet printer disposes images on a dough sheet, which is cut into individual pieces then fried to form fabricated snack chips.

In another aspect of this invention the distance from the upper surface of the substrate to the lower most surface of the nozzle is from about 0 millimeters (mm) to about 10 mm, preferably from about 0.2 mm to about 8 mm, even more preferably from about 0.5 to about 5 mm, and yet most preferably from about 1 mm to about 3 mm.

In another aspect of the present invention the ink jet printer prints the image on the substrate by controllably dispensing ink and wherein the ink is dispensed at a temperature greater than about 40° C. It is preferred that the ink is dispensed at a temperature greater than the dew point of the air adjacent the nozzle. In yet another aspect of the present invention the viscosity of the ink at the applied temperature is less than about 30 centipoise.

In yet another aspect of this invention at least two ink jet printers are used to back up each other, and when both printers are operational, they both are used to print often enough to keep the nozzles primed and near their operating temperature.

The processes and products of this invention provide improved reliability of the printing operation on edible substrates. In one embodiment, the reliability of the printing operation is improved by relying on dual printing units that share the printing load, and in this way, eliminating the need to prime or ready a spare printing unit if a single printing unit malfunctions. That is, with two or more printing units sharing the load, all of the units are primed and in actual operation, and anyone of them is able to take over the full printing load in case the other malfunctions, at an instant, without stopping the production flow. Moreover, the reliability of the printing operation is improved by a detection system that alerts and automatically removes the printing units from the printing location, if such detection systems detects that an anomaly (e.g. thicker edible substrate, dirt particles, wrinkles in a substrate) in the edible substrate, would impact the printer head unit, causing likely damage and downtime to repair. And in yet another embodiment, the reliability of the printing operation is improved by avoiding condensation on the printer heads by keeping them at a temperature above the dew point of the environment where they operate to avoid condensation of moisture that can damage the printer head, create image quality issues, or sanitation issues. Those skilled in the art will appreciate that combinations of the above processes can be used to further improve the reliability of a printing operation on edible substrates.

### BRIEF DESCRIPTION OF THE DRAWINGS

While this specification includes a description of the present invention and concludes with claims that define the invention, it is believed that both will be better understood by reference to the drawings wherein:

FIGS. 1 and 2 are schematic representations of image files suitable for use in the present invention; and

FIG. 3 is a partial schematic representation of a substrate printing process according to the present invention.

### DETAILED DESCRIPTION OF THE INVENTION

All documents cited herein are incorporated by reference in their entirety. The citation of any document is not to be construed as an admission that it is prior art with respect to the present invention.

Although the invention herein will generally be described in terms of printing on a dough sheet, it should be understood that any suitable edible substrate sheet is within the scope of the present invention.

As used herein, “sheet” can include a substrate that has been shaped, extruded or roll-milled in such a way as to provide a flattened surface on the substrate.

As used herein, “stream” means a continuous source of substrates. For example, a stream of substrates can include a plurality of substrates such as that provided by a conveyor belt or as a feed from a continuous, semi-continuous, or batch process.

As used herein, “edible substrate” or “substrate” includes any material suitable for consumption that is capable of having an image disposed thereon. Any suitable edible substrate can be used with the invention herein. Examples of suitable edible substrates can include, but are not limited to, dough sheets. Furthermore, suitable edible substrates can include snack chips, fabricated snacks (e.g., fabricated chips such as tortilla chips, potato chips, potato crisps), extruded snacks, cookies, cakes, chewing gum, candy, bread, fruit, dried fruit, beef jerky, crackers, pasta, sheets of meat, sheets of cheese, pancakes, waffles, dried fruit film, breakfast cereals, and toaster pastries.

As used herein, “fabricated snack piece” or “snack piece” is broad enough to include a snack piece that has not yet been separated (e.g., cut) from a dough. For example, in one embodiment, an image is disposed upon a dough sheet, then the dough sheet is later cut into individual pieces. Furthermore, “fabricated snack piece” or “snack piece” is broad enough to include both cooked (e.g., fried) and un-cooked (e.g., dough) substrates.

A. Providing an Edible Substrate

According to the present invention, an edible substrate sheet is provided. The edible substrate sheet can be in the form of a continuous sheet or stream comprised of edible material that is later divided into many resulting individual pieces. In one embodiment, the edible substrate sheet is a dough sheet.

In a preferred embodiment, the edible substrate comprises a dough sheet used to fabricate a fabricated snack piece, preferably a fabricated snack chip, and more preferably a fabricated potato crisp. Suitable snack pieces include those described in “Chip Frying Machine,” U.S. Pat. No. 3,520,248, issued Jul. 14, 1970, to MacKendrick; “Preparation of Chip-Type Products,” U.S. Pat. No. 3,576,647, issued Apr. 27, 1971, to Liepa; “Apparatus for Preparing Chip-Type Products,” U.S. Pat. No. 3,608,474, issued Sep. 28, 1971, to Liepa; and “Molding Device for Preparing Chip-Type Products,” U.S. Pat. No. 3,626,466, issued Dec. 7, 1971, to Liepa; Lodge in U.S. Pat. No. 5,464,643, and Villagran et al. in U.S. Pat. No. 6,066,353 and U.S. Pat. No. 5,464,642. In one embodiment, the fabricated snack chip is a fabricated potato crisp, such as that described by Lodge in U.S. Pat. No. 5,464,643, and Villagran et al. in U.S. Pat. No. 6,066,353 and U.S. Pat. No. 5,464,642. Other snack chips that can be used herein include those described in “Process for Making a Corn Chip with Potato Chip Texture,” U.S. Pat. No. 4,645,679, issued Feb. 24, 1987 to Lee, III et al.

In addition, the edible substrate can include pet foods such as, but not limited to, dog biscuits and dog treats.

The edible substrate can be in any suitable form. For example, the substrate can be a finished food product ready for consumption, a food product that requires further preparation before consumption (e.g., snack chip dough, dried pasta), or combinations thereof. Furthermore, the substrate can be rigid (e.g., fabricated snack chip) or non-rigid (e.g., dried fruit film). In one embodiment, the edible substrates are connected to one another (e.g., in the form of a dough sheet prior to cutting the individual pieces).

B. Providing an Image Source

As used herein an “image source” includes any collection of one or more images. For example, the image source can be an electronic (e.g., computer-based) database, a plurality of databases, or a collection of hard-copy images. The image can be single-color or multi-color. The image can comprise dyes, pigments, other natural or synthetic substances, flavors or combinations thereof. The image can be disposed on the edible substrate before or after a cooking process (e.g., before or after a dough sheet is baked or fried). Furthermore, the image can be disposed on the edible substrate before or after it is cut into individual pieces (e.g., before or after a dough sheet is cut into individual cookie or snack chip pieces). In a preferred embodiment, an ink jet image is printed on a fabricated snack chip. More than one surface of the edible substrate can have an image disposed thereon. A plurality of image disposal devices can be employed, each one to dispose an image on a different side of the edible substrate (e.g., top, bottom, and/or side).

The image disposal device comprises an ink jet printer. Preferably, the image is disposed by digital printing is, such as ink-jet printing systems (e.g., continuous jet, drop-on-demand), such as those described in WO 01/94116 by Willcocks et al., published Dec. 13, 2001. The use of ink jet printer heads to print snacks offers the potential to print many different images in succession over multiple consecutive edible products to create interest on the consumer of these edibles. Also, the non-contact printing realized improves the ability to meet sanitation guidelines over extended runs without needing to stop production to clean equipment. Using ink jet printers also create new challenges to solve to enable a reliable operation, which is needed for economic viability.

Images can be in any suitable form, preferably electronic media such as that generated using computer software and stored on an electronic storage device, such as a computer, computer disk, RAM, or ROM, or visual display. Any suitable computer system, as known in the art, can be used.

Images from said image source can be used by the image disposal device in any suitable sequence, such as a repeating sequence, at random, or any predetermined order.

Preferably, all the images in the image source are different from one another. However, in one embodiment, at least two of the images in an image source are the same.

Any suitable image can be used. The image can comprise one or more graphic elements, one or more text elements, or combinations thereof. As used herein, “text” means one or more alpha-numeric symbols. Text can include letters, numbers, words, and combinations thereof.

As used herein, “graphic” means pictorial representation. For instance, the graphic can include objects, symbols, scenes, people, animals, toys, or characters. Suitable characters can include cartoon characters and licensed characters, as well as characters associated with popular personalities in the media, advertising, or well known in the particular culture.

Non-limiting examples of suitable images include letters, numbers, words, animals, cartoon characters, popular figures from the media, caricatures, historic events, and photographs.

Furthermore, images can be in the form of full or partial words, numbers, clues, hints, jokes, revelations, trivia quizzes, photographs, pictures, puzzles, stories, games, or sequence of events (e.g. animations). For example, the image can comprise the question portion of a trivia quiz. In one embodiment, the image depicts a piece of a jig-saw puzzle.

When printing multiple images on an edible substrate, it is necessary to instruct the printer when to begin printing each image. One such way of providing those instructions is via a trigger pulse signal. Trigger pulse signal printing is described in detail in co-pending U.S. patent application Ser. No. 60/669,094, filed on Apr. 7, 2005, the entire disclosure of which is incorporated by reference. Those skilled in the art will appreciate that there are other methods known to the art for image registration that are suitable for use with the present processes.

C. Using Redundant, Continuously Primed Printer Heads

Ink Jet printer heads require periodic maintenance, usually in the form of ink purges or general cleaning, to sustain 100% nozzles jetting. This maintenance takes the printer head out of operation, causing lost production and downtime. Having a spare, redundant printer head allows the operator to perform this maintenance while continuing to produce product using the spare head.

But ink jet printer heads that are not in use require time to warm up and must be primed before they are operational. To maximize production up-time, it is advantageous to switch over to the redundant head quickly. This necessitates having the spare head be primed and at the appropriate temperature for printing. It is also important to have the spare head in operating position at the proper distance from the substrate, and calibrated to target the proper points on the substrate. However, maintaining ink in a printer head with an established meniscus and ready to jet is a potential problem for DOD ink jet systems.

One method of achieving this is to use both printer heads in production in “toggle” mode, whereby the printer heads share the printing load. In one example of the toggle mode, the first printer head prints every other edible substrate while the second printer head prints the remainder edible substrates. In another embodiment, the first printer head prints for a fixed amount of time (e.g. 30 seconds) and the second printer head prints for the same amount of time after the first printer head finishes printing, and then the first printer head starts printing again, and so on. In yet another embodiment, the first printer head prints for about 50% of the time in a given time period, and the second printer head prints for the about the other 50% of the time. Toggling not only keeps the spare printer head ready for use, but it also increases the Mean Time Between Failures (MTBF) by decreasing the duty that is required of each printer head. That is if each head can generate 10 million drops on average before de-priming, now a total of 20 million drops can be produced before a head fails. Also, the MTBF for the overall printing system, when both units are simultaneously malfunctioning is significantly much higher than 20 million drops. While the foregoing description is based on increasing the number of printer heads from one to two, those skilled in the art will appreciate the benefits of having three or more printer head operating in the toggle mode.

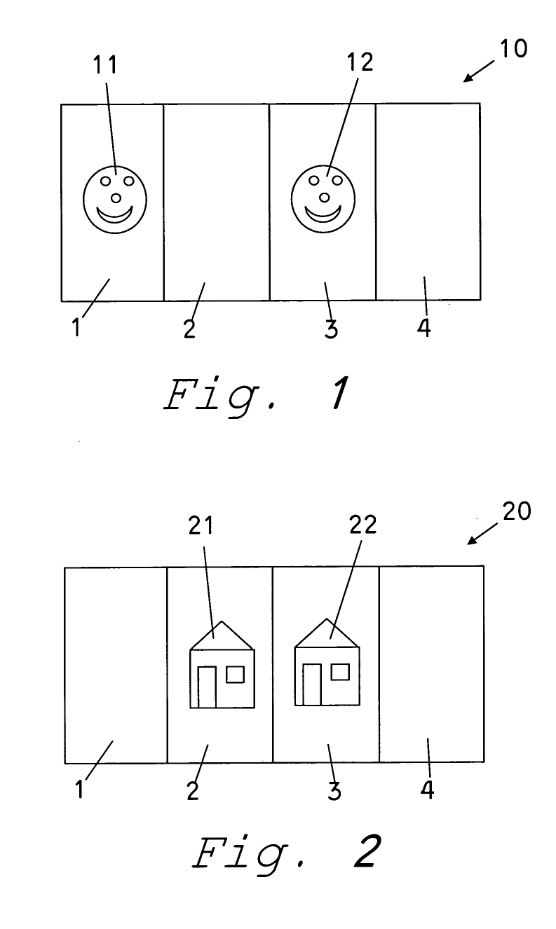

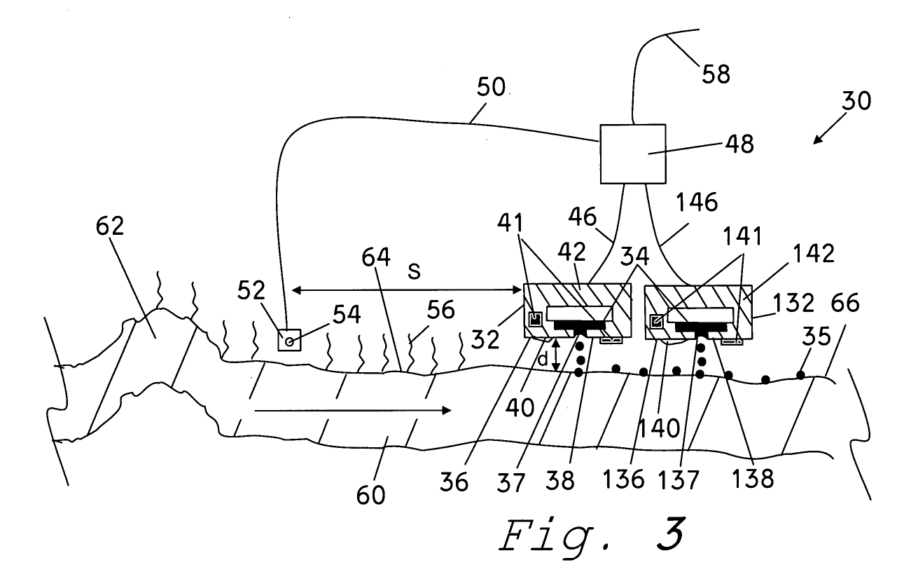

A simple way to accomplish toggling between two printer heads, for example printer heads 42 and 142 shown in FIG. 3 and described in greater detail below, relies on the design of the image information file, and how multiple image information files are ordered in a sequence. In one embodiment, an image information file 10 comprises four distinct portions that can be addressed independently by a printer head depending on the operation mode (i.e., toggle mode versus a dedicated unit printing all images), wherein each of the portions serves a different purpose. FIGS. 1 and 2 show representations of image information files 10 and 20, comprising the four portions or banks 1, 2, 3 and 4. Bank 1 and Bank 2 are used when the operation is set to toggle mode, and Bank 3 and Bank 4 are used when a dedicated printer head is selected. When in toggle mode, first printer head 42 always addresses Bank 1 and second printer head 142 always addresses Bank 2. When a dedicated printer head is selected (either first printer head 42 or second printer head 142), the dedicated printer head always addresses Bank 3 and the inactive printer head addresses Bank 4. Thus, the images sent to the printer heads contain all the necessary information to print in toggle mode and dedicated mode. By this method, switching between toggled printer heads and one dedicated printer head requires no change in the image programs.

More specifically, for a given image information file, either Bank 1 or Bank 2 will have an image and the other, Bank 2 or Bank 1 respectively, will remain blank. Also, Bank 3 will have the same image as that in either Bank 1 or Bank 2, and Bank 4 will always remain blank. Given this approach, we may now order image information files such that in a first image information file 10, it is Bank 1 which carries an image 11, while Bank 2 remains blank, and such that in a second consecutive image information file 20 it is Bank 2 which carries an image 21 while Bank 1 remains blank. Alternating which bank between Bank 1 and Bank 2 carries an image in a sequence of image information files, enables a first printer head 42 and second printer head 142 to toggle or share the printing load over time. Note that in this approach an image information file is used for every edible substrate designated to be printed, but which printer head is used to actually print the image information is selected by designating which bank actually has the image. Note also that if both Bank 1 and Bank 2 were to carry an image, whether the same or not, then both printer head first 42 and second printer head 142 would print the corresponding image in their respective bank, if the mode is set to toggle, where Bank 1 and Bank 2 are the banks being addressed.

The operator can choose to toggle or not at her own discretion. When she chooses to toggle versus using a dedicated printer head, then the sequence of image information files to be used for printing over multiple edible substrates determines if ink is ejected from a particular printer head for a given edible substrate.

In an alternate embodiment, a first part of an image to be printed is located in the Bank 1 of an image information file, while a second part is located in the Bank 2 of the image information file. In this way, both printer heads share in the printing of a single image. In this case, Bank 3 comprises a composite of the first and second portions located in Banks 1 and 2 respectively, while Bank 4 remains blank, so a printer head can print the entire image when the mode is set to a dedicated printer head printing.

D. Anomaly Detection and Avoidance

When working with ink jet technology a key challenge is to keep the printer head orifice clear from obstructions. This challenge is exacerbated when working with substrates that are viscoelastic or sticky in nature, such as a dough sheet because the printer head must be at a short distance from the substrate to be printed. The preferred distance “d”, FIG. 3, between the lower most surface 36 of nozzle 38 of a DOD inkjet printer head (either 42 or 142) and the dough sheet upper surface 64, that is, the substrate to be printed, is from about 0 to about 10 milimeters (mm), preferably from about 0.2 to about 8 mm, more preferably from about 0.5 to about 5 mm, and most preferably from about 1 to 3 mm. This short distance “d” minimizes the effect of droplet trajectory variations from the printer head orifice towards the substrate to be printed that can grow over a longer distance and result in poor image quality. This short distance, however, exposes the printer head orifices to variations and anomalies, for example 62, which are common in the production of the dough sheet, and which can impact the printer head. Exemplary anomalies include but are not limited to dough sheet thickness variation, dough sheet wrinkles, dough sheet tears or fold outs, and dough particles riding over the dough sheet.

Turning again to FIG. 3, which depicts a dough printing process 30 according to the present invention, one such anomaly 62 is shown on dough sheet 60 which is traveling in the direction of the arrow toward first printer head 42 and then toward second printer head 142. If anomaly 62 of dough sheet 60 impacts either of printer heads 42 or 142, short term interruptions in jetting are likely as well as potential longer term damage to the equipment. This can span from a short term image quality variation, to printer head failure requiring down time to correct the problem or replace the printer head, both of which can be costly in terms of production time costs and equipment costs. To avoid this problem surface profile reader 52 sends a profile sensor 54 above the dough sheet upper surface 64 to look for anomalies, for example 62. The profile sensor 54 is preferably parallel to the dough sheet upper surface 64, is located at a distance no higher than the distance “d”, FIG. 3, and spans over at least the width of the dough sheet that corresponds to the locations to be covered by the printer heads. The profile reader can be a laser based detector that detects if something crosses the laser path indicating that an anomaly may impact printer heads 42 or 142. Alternatively, profile sensor 54 can detect anomalies by other known methods, for example measuring the height of dough sheet upper surface 64 relative to a fixed, stationary point. The profile reader must necessarily be placed before the printer heads, that is, before the dough sheet 60 is printed.

Surface profile reader 52 is in communication with ink jet printer heads 42 and 142 via surface profile signal 50 which communicates with signal processor 48. Signal processor can be any of a variety of known processing units, for example a simple lap top or desk top computer will suffice. Signal processor 48 sends printer head signals 46 and 146 to printer heads 42 and 142. Likewise, signal processor 48 can receive an image signal 58 and transmit it to printer heads 42 and 142 via printer head signal 46 and 146. Those skilled in the art will appreciate that while one signal processor is shown, multiple processors may be used.

Printer heads 42 and 142 must be able to move away from or toward, dough sheet upper surface 64 in response to a surface profile signal 50 generated by surface profile reader 52. Preferably printer heads 42 and 142 move in a direction perpendicular to dough sheet 60. It is understood that the distance “S” between surface profile reader 52 and first printer head 42 must be sufficient to give printer heads 42 and 142 sufficient time to move before contacted by anomaly 62. Distance “S” can be easily determined by those skilled in the art and will be based on the speed that dough sheet 60 travels and the speed with which printer heads 42 and 142 can be raised.

It is understood that while anomaly 62 is shown as a protrusion from dough sheet 60 which might contact first printer head 42, an anomaly might be a depression in dough sheet 60. Since optimal printing is achieved when distance “d” is maintained at a constant value, printer heads 42 and 142 should preferably be able to move towards and away from dough sheet 60. It is, however, most important that printer heads 42 and 142 move away from dough sheet 60 to avoid collision with protruding anomalies such as 62. It is also understood that nozzles 38 and 138 can be moved in a direction away from dough sheet 60, preferably in a perpendicular direction, by moving the inkjet printer, retracting the nozzles, extending the nozzles or combinations of these.

Any lifting mechanism (not shown) that raises printer head 42 and 142 over the substrate to a safe distance to avoid the collision can be used herein. For example, printer heads 42 and 142 can be mounted on a rack controlled by a servo motor that actuates when printer head signals 46 and 146 are received. The speed of movement of printer heads 42 and 142 must be considered to avoid de-priming nozzles 38 and 138 as may occur with a fast acceleration of the printer head movement particularly if such acceleration is greater than about 10 m/s². This is important to maintain the printer head ready to print upon clearing of the anomaly.

In another embodiment (not shown), the distance between the printer head and the substrate can be increased by lowering the substrate conveyor belt under the printer head to make room for the anomaly. In this case, the printer head can remain stationary and fast accelerations of printer heads are eliminated. In yet another embodiment surface profile signal 50 may be used to stop dough sheet 60 from moving under printer head 60, to enable clearing anomaly 62 before further production. In any of the embodiments above, the production system can be optionally set up to discard any edibles that have not been printed as a result of handling the anomaly.

An alternative approach to handling dough anomalies is to perform an operation before printing to ensure a uniform substrate is presented to the printer head. One such example is a roller placed over the substrate to flatten any irregularities in the substrate. Alternatively, a stream of air can be directed at the substrate to remove any large particles or correct any folds in the substrate.

E. Condensation Prevention

The sensitivity of the ink jet printing equipment to the hot and humid environment, and to the high speed manufacturing processes, such as those used to produce edible substrates, stresses the printing equipment. The following describes processes to improve the reliability of the printing equipment which may be used individually or in combination to further improve reliability.

Edible substrates typically contain some amount of water. A dough sheet in particular may contain high levels of water, and, depending upon the temperature of the dough sheet, a substantial amount of this moisture may evolve from the surface of dough sheet 60 in the form of steam 56. This creates additional challenges to using an ink jet printer over this substrate. Specifically, steam 56 may condense 40 and 140 anywhere on the outer surfaces 32 and 132 of printer heads 42 and 142. Condensation 40 and 140 on the printer heads 42 and 142 will cause several problems, including image quality issues, sanitation issues and reliability problems. As condensate blocks printer head nozzle orifices 37 and 137, the ejection of ink droplets 34 is negatively affected. Ejection may be stopped entirely, or the ink droplet trajectory may be changed, both of which will negatively impact image quality. Also, as water accumulates or remains stagnant over a long period, there exist the potential for microorganism growth on the printer head's outer surfaces 32 and 132. Any of these problems will, in turn, require down time to correct the situation.

To avoid moisture condensation on printer heads 42 and 142, the temperature of the printer heads is raised above the dew point of the air adjacent printer head 42 and 142. Any common heating element 41 and 141 can be used to elevate the temperature of printer head outer surfaces 32 and 132. The heating elements 41 or 141 may be located on the outer surfaces 32 or 132 or located within the ink jet assembly 42 or 142, or both. Ink 34 used in printer heads 42 and 142 is formulated to work at this elevated printer head temperature. The preferred printer head temperatures for printing over edible substrates are from about 40° C. to about 90° C., preferably from about 50° C. to about 80° C., most preferably from about 55° C. to about 70° C. Condensation reduction can be further achieved by decreasing the temperature of the substrate and controlling the amount of steam evolution from said substrate by, for example, lowering the temperature of the surrounding air or by using less water in the dough. But as is discussed below, this has negative impacts on the ink, and specifically the ink drying/setting time. As such, decreasing the surrounding temperature may help with one problem but it creates another. Moreover, those skilled in the art will appreciate that high operating temperatures decrease the life of electrical components in printing equipment by about 50% for every 10° C. temperature increase. Thus, it is desirable to keep the dew point of the environment above the substrate as low as possible, while maintaining good ink flow as described below.

F. Printing, Cutting and Cooking the Edible Substrate

Ink 34 is periodically ejected onto dough sheet upper surface 64 when image signal 58 is received by piezo electric printer heads 42 and 142, which activate ink ejection through printer head orifices 37 and 137. This in turn, creates printed image 35 on printed dough sheet 66. Printed dough sheet 66 can then be cut into fabricated snack pieces (not shown). As discussed above, cutting may occur before printing. Any suitable cutter can be used. For instance, rotary or stamp cutters can be used. Likewise, there may be one or more images printed on each fabricated snack piece. The fabricated snack pieces are then cooked, by for example, baking frying, boiling, grilling, or the like. Preferably, the fabricated snack pieces are fried in oil to produce a snack chip.

G. Fast Setting Ink For Edible Substrates

In addition to the challenges mentioned above when printing on edible substrates like dough sheets with high reliability, the ink presents a different set of issues. Necessarily, the ink must by edible and non-toxic, which places substantial restrictions on the ink formulations that can be used on edible substrates. Ink is largely a two component system, colorant, for example, dye or pigment, and the carrier or solvent. Both components must be edible and non-toxic. One key parameter of the ink is its setting time. Edible substrates are typically produced, printed and then cooked in high speed continuous processes. If the ink is cooked, for exampled fried in oil, before it is completely dry, the image quality will deteriorate. Moreover, ink has a tendency to spread as it dries blurring the image. Thus, as the drying time is reduced, spreading is reduced and image quality is increased. Hence, it is advantageous to have inks that dry as quickly as possible when placed on an edible substrate.

In addition, to maintaining image quality, fast setting of ink is important to prevent the ink from adhering to equipment surfaces in contact with the printed edible substrate or avoid the ink from ending up in the frying oil of a subsequent frying step of the dough sheet. If ink is able to transfer to other equipment surfaces upon contact, then this can also result in undesirable smearing or bleeding of the ink, and may also result in down time to clean the equipment. If the setting time is slow, then that also requires a longer distance between the printer head and a subsequent unit operation that may contact the printed side of the dough sheet to avoid the undesired ink transfer to other equipment surfaces. A larger distance between the print head and a subsequent unit operation can also be problematic if said unit operation is a dough sheet cutting operation that must be registered to the printed portions on the dough sheet. Co-pending application Ser. No. 60/669,094, filed on Apr. 7, 2005, “Image Registration On Edible Substrates” describes a method to accomplish image registration by printing on a dough sheet such that the printed images will coincide with cutter molds of a subsequent dough cutting step. If the distance between the printer head and the dough sheet cutter is increased then additional variability is introduced in registering of images with cut portions of the dough sheet that may be undesirable.

To address these issues, we have identified the factors that enable the fast setting of edible inks, and discovered the optimal parameters in which to work. These fast drying factors include: the nature of the colorant; the type of solvent or carrier used for the colorant; the viscosity of the ink when it is applied to the substrate; and the conditions of the edible substrate, specifically, its moisture content and temperature. These factors are discussed in turn below, and an exemplary ink composition is described in the Example below.

Nature of Colorant

Dyes and pigments are common colorants used in inks. Of these, dyes are the preferred colorant for use in printing of edible substrates such as dough sheets. Dyes solubilize in typical ink solvents and remain in solution minimizing clogging of print head nozzles. Also, dyes remain in solution upon application and can permeate into the dough sheet with the rest of the ink, to become well adhered to the dough sheet. Pigments are non soluble and must be dispersed and kept in suspension. Agglomeration of pigment particles or large particles sizes can lead to nozzle clogging which impact image quality and process reliability. Also, upon application to a dough sheet, pigments may stay on the surface of the substrate even if the remainder of the ink is absorbed into the dough matrix. This can lead to staining of equipment surfaces that become in contact with the printed substrate.

Solvent or Carrier for Colorant

The vast majority of an ink comprises the solvent or carrier for the colorant. We have found that to achieve fast setting times, it is important to use a solvent or carrier that is compatible with the substrate on which printing is to occur. In the case of a dough sheet that typically carries a substantial amount of water, it is important that the solvent or carrier exhibit polar characteristics. Glycol based solvents like propylene glycol or hygroscopic components like glycerine are examples of polar solvents suitable for printing on edible substrates like dough sheets. Upon contact with the dough sheet, they will absorb some of the water in the dough and create a strong bond with the dough sheet that causes the dye to become firmly bound to the dough even before drying.

Conditions of Dough Sheet

The temperature and moisture content of the dough sheet can impact the setting time of inks on the surface of said dough sheet and the amount of bleed that may occur. The substrate temperature affects the viscosity of the ink on the surface. Specifically, as the temperature of the substrates upper surface increases, the viscosity of the ink decreases allowing it to enter the surface more quickly. Dough sheet temperatures from about 30° C. to about 75° C., preferably from about 40° C. to about 70° C., more preferably from about 45° C. to about 65° C., and most preferably from about 50° C. to about 60° C. will substantially improve the setting of ink. It is understood, however, that the dough conditions have a pronounced affect on the potential for condensation on the printer head nozzles as is discussed above.

### EXAMPLE

Ink Composition

An exemplary ink composition suitable for use in the present invention is given below in Table 1. This composition is successfully delivered with a DOD piezo inkjet print head at about 52° C. to print on a potato based dough sheet as used to make stackable potato chips.

TABLE 1

| Material | % by Weight |
|---|---|
| Propylene Glycol | 92% |
| Glycerine | 4% |
| Isopropyl Alcohol | 2% |
| FD&C Blue No 1 | 2% |

Ink Setting/Drying Time

The ink defined in Table 1 is applied to a potato based dough sheet at a temperature of about 27° C. and the setting time is about 15 seconds, measured according to the methods given below. In another case, a similar dough sheet is printed with the same ink, wherein the temperature of the dough sheet is 60° C. and the setting time is about 3 seconds, which is substantially shorter than when the dough sheet temperature was 27° C.

While not wanting to be bound by any one theory, it is believed that at the higher temperatures the starch granules swells and produce additional hydroxyl bonding sites. These bonding sites may improve the adherence of dough and the polar components of the ink, and particularly propylene glycol and the dye. Also it is believed that at the higher temperature of the dough, the ink may experience a reduction in viscosity that promotes its fluidity into the dough matrix by capillary action. Additionally, forming a dough sheet at the higher temperatures, helps to accelerate the rate of free water evaporation from the surface of the dough sheet. This is important since a moist surface may result in ink bleeding and slow setting and drying.

Analytical Method for Measuring Ink Setting/Drying Time

This method determines if a printed ink has set on a substrate.

A dough substrate is printed and then contacted by an equipment surface material after a pre-determined amount of time. The equipment surface material is then made to contact a paper towel to determine if any ink has transferred by visual inspection The weight of the paper towel can also be measured before and after and the difference indicates the weight of ink transferred.

Materials

1. A piece of Teflon surfaced material mounted on a hand stamp. The surface area of the material is large enough to cover the area of the printed image in the test. The force exerted by the hand stamp with the Teflon surfaced material over a surface by virtue of its own weight is 45 grams per square inch.
2. A DOD ink jet printer set up to print over the intended edible substrate, and such that the printed substrate is available for testing at various times in the production process.
3. An edible substrate.
4. A square checker board like image of about 1.25 inches side dimension with an ink density of 203 dots per inch of printed and unprinted rectangles is used providing densely inked areas adjacent to areas with no ink. The image contains eight columns of rectangles in its width, and five rows of rectangles in its height

Operator Calibration

An operator shall press the hand stamp on a gram unit digital scale until he can reproduce the listed numbers. Stamper pressure has been designated as
a. Gravity (˜45 g/in²): the weight of the stamper with no added force from the operator.
b. Light pressure (˜70 g/in²): weight of stamper and the operator's hand.
c. Heavy pressure (˜450-900 g/in²): pressing heavily with hand and arm.

Substrate Requirements

Create a continuous stream of consistent substrate run under the print head at a continuous velocity.

Positioning of Print Head Unit Over the Substrate

The printer shall be positioned such that at the running substrate velocity, there shall be enough belt length so that sampling may be conducted 1, 5 & 15 seconds after deposition of ink onto substrate.

Testing for 1, 5 and 15 Seconds from Printing
1. Locate a position downstream from print head, 1 second from ink deposition. If substrate velocity is X feet per minute, this would correspond to a distance of X/60 feet from print head.
2. Using a clean and dry stamper, make one contact on the printed image and immediately press stamper onto a paper towel with no lateral motion or smearing.
3. Locate a position downstream from print head, 5 seconds from ink deposition. If substrate velocity is X feet per minute, this would correspond to a distance of X/12 feet from print head.
4. Using a clean and dry stamper, make one contact on the printed image and immediately press the stamper onto a paper towel like before.
5. Locate a position downstream from print head, 15 seconds from ink deposition. If substrate velocity is X feet per minute, this would correspond to a distance of X/4 feet from print head.
6. Using a clean and dry stamper, make one contact of printed image and immediately press stamper onto a paper towel like before.
7. Compare ink transfer onto the paper towels for various time points and also versus other dough substrates and conditions. The test may be repeated for other time points other than those specified to more accurately determine a time point when no ink transfer occurs from the substrate to the stamper and then to the paper toweling. Also the stamper pressure may be varied between gravity, light pressure and heavy pressure to understand the impact for a particular process condition. The ink is “set” when no visible ink is transferred to the paper towel.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A process for making edible substrates comprising the steps of:
a) forming a substrate having an upper surface;
b) providing at least one ink jet printer;
c) printing an image onto the substrate with the inkjet printer to form a printed substrate; and
d) cooking the printed substrate.

2. The process of claim 1 wherein the inkjet printer is a drop-on-demand (DOD) piezoelectric ink jet printer.

3. The process of claim 1, wherein the ink jet printer comprises at least one nozzle with a lower most surface, and where the distance from the upper surface of the substrate to the lower most surface of the nozzle is from about 0 millimeters to about 10 millimeters, preferably from about 0.2 millimeters to about 8 millimeters, even more preferably from about 0.5 millimeters to about 5 millimeters, and yet most preferably from about 1 millimeter to about 3 millimeters.

4. The process of claim 1, wherein the ink jet printer prints the image on the substrate by controllably dispensing ink and wherein the ink is dispensed at a temperature greater than about 40° C.

5. The process of claim 3, wherein the ink jet printer prints the image on the substrate by controllably dispensing ink and wherein the ink is dispensed at a temperature greater than the dew point of the air adjacent the nozzle.

6. The process of claim 1, wherein the ink jet printer prints the image on the substrate by controllably dispensing ink and wherein the viscosity of the ink at the applied temperature is less than about 30 centipoise.

7. The process of claim 3, wherein there is further provided a surface profile reader that determines if the actual height of the upper surface of the substrate is different than the theoretical height of the upper surface when it is a pre-determined distance away from the printer head nozzle.

8. The process of claim 7 wherein the surface profile reader is in communication with a means to move the nozzle of the ink jet printer, and the nozzle can move in a direction away from and preferably perpendicular to, the substrate in response to any change in height of the upper surface of the substrate as detected by the surface profile reader.

9. The process of claim 8 wherein the surface profile reader is sufficiently far apart that when the surface profile reader detects a change in the height of the upper surface of the substrate and sends a signal to the means to move the nozzle of the ink jet printer, there is sufficient time to adjust the height of the nozzle accordingly.

10. The process of claim 8 wherein the nozzle is moved in a direction perpendicular to the substrate by moving the inkjet printer, retracting the nozzle, extending the nozzle or combinations of these.

11. The process of claim 1 wherein there are at least two ink jet printers and when both printers are operational, they both are used to print often enough to keep the nozzles primed and near their operating temperature.

12. The process of claim 1 wherein the substrate is cut into individual fabricated snack pieces before the dough is cooked, and further wherein each fabricated snack piece has at least one image printed thereon.

13. The process of claim 12 wherein the individual fabricated snack pieces are cooked by frying them in oil to produce a snack chip.

14. A snack chip made according to the process of claim 13.

15. The process of claim 1, wherein the ink jet printer prints the image on the substrate by controllably dispensing an edible ink that comprises a colorant and a polar solvent.

16. The process of claim 15, wherein the colorant is a dye.

17. The process of claim 15, wherein the polar solvent is glycol based.
